(19) United States
(12) Patent Application Publication
(10) Pub. No.: US 2010/0061586 A1
(43) Pub. Date: Mar. 11, 2010

(54) TV WITH VIEWER-ADAPTED HEIGHT AND ANGLE ADJUSTMENT

(75) Inventor: Meeta Jain, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/207,940

(22) Filed: Sep. 10, 2008

(51) Int. Cl. G06K 9/00; F16M 11/04

(52) U.S. Cl. 382/100; 248/187.1

(57) ABSTRACT

The height and angular orientation of a TV on a movable stand are automatically adjusted based on viewer position as imaged by a camera and analyzed by image recognition algorithms.

### FIELD OF THE INVENTION

The present invention relates generally to TVs the height and/or angular orientation of which are automatically adjusted based on viewer location.

### BACKGROUND OF THE INVENTION

TVs are typically disposed in a room for viewing at heights and angles that are not changed regardless of where the viewer is unless the viewer might take the effort to manually move the TV. Even then, particularly in the case of raising or lowering the TV, the viewer may be able to make at most limited changes in height if any at all.

### SUMMARY OF THE INVENTION

A system includes a movable support assembly configured to support a TV. The system also includes a person sensor configured to sense a viewer of the TV. A processor receives signals from the person sensor to determine a viewer angle parameter and a viewer distance parameter. Based on the parameters the processor automatically establishes an angular orientation of the movable support assembly and a height of the movable support assembly.

In example implementations the movable support assembly can telescope relative to a base in which the movable support assembly reciprocates. The processor may execute a face recognition module to determine the parameters. If desired, the processor can wait for the elapse of a steady state period in the event that one or more detected viewers are moving at a speeds and distances greater than a motion threshold prior to moving the movable support assembly.

In some example embodiments a viewer can establish a correlation between at least one viewer distance parameter and a height of the movable support assembly. If multiple viewers are detected, the parameters can be averages of corresponding individual viewer parameters.

In another aspect, a system includes a movable support assembly configured to support a TV. The system also includes a person sensor configured to sense a viewer of the TV. A processor receives signals from the person sensor to determine a viewer distance parameter. Based on the viewer distance parameter the processor automatically establishes a height of the movable support assembly.

In another aspect, a system includes a movable support assembly configured to support a TV. The system also includes a person sensor configured to sense a viewer of the TV. A processor receives signals from the sensor to determine a viewer angle parameter. Based on the viewer angle parameter the processor automatically establishes an angular orientation of the movable support assembly. The processor waits for the elapse of a steady state period in the event that one or more detected viewers are moving at a speeds and distances greater than a motion threshold prior to moving the movable support assembly.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of a TV on a stand that can be rotated and raised/lowered in height, schematically showing some of the internal TV components;

FIG. 2 is a block diagram of an example non-limiting system for automatically moving the TV stand, which uses a motor for rotating the TV and another motor for establishing the height of the TV;

FIG. 3 is a block diagram of an alternate non-limiting system for automatically moving the TV stand, which uses a single motor for both rotating the TV and establishing the height of the TV;

FIG. 4 is a flow chart of example logic for automatically establishing the angular orientation of the TV; and

FIG. 5 is a flow chart of example logic for automatically establishing the height of the TV.

### DETAILED DESCRIPTION OF THE PREFERRED EMBODIMENT

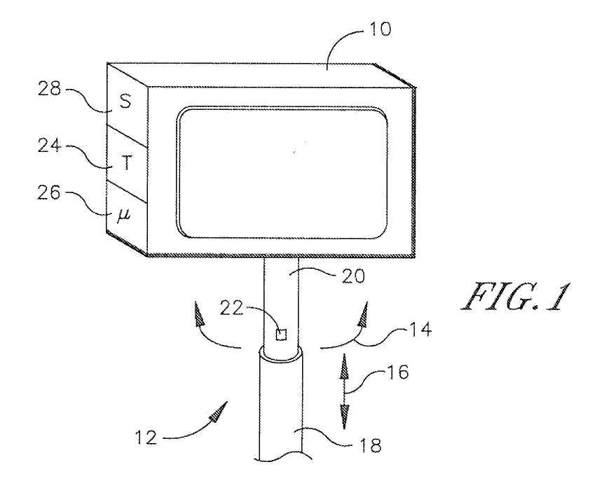

Referring initially to FIG. 1, a TV 10 can be supported on a stand 12 that can rotate as shown by the arrows 14 to establish an angular orientation of the TV 10, and/or that can raise and lower as shown by the arrows 16 to establish a height of the TV 10. In the example non-limiting embodiment shown the stand 12 includes a stationary hollow base 18 and a movable support 20 that can rotate with respect to the base 18 and/or telescope with respect to the base 18. In general a movable support assembly can include a single movable support 20 as shown or separate rotating and telescoping supports. A person sensor 22 such as but not limited to a digital video camera may be provided with the illustrated system on, e.g., the stand 12 as shown or on the TV 10 or on another suitable component. IN other embodiments the person sensor 22 may be, e.g., an IR sensor.

The TV 10 may include a cathode ray tube or a flat panel display. The TV 10 may be a standard definition or high definition TV and may be an analog or digital TV. Typically the TV 10 (which encompasses standalone TVs as well as TV-set top box combinations) includes a TV tuner 24, a TV processor 26 communicating with the TV tuner 26, and a tangible computer-readable medium 28 such as solid state storage, disk-based storage, etc. that is accessible to the TV processor 26.

FIG. 1 shows an example implementation in which the TV 10 is supported on the stand 12. The TV 10 may be integral with the stand 12, and/or the stand 12 may be a stand-alone device that can be placed in a viewing room or that can be wall-mounted (i.e., mounted in or on a wall) to move a wall-mounted TV.

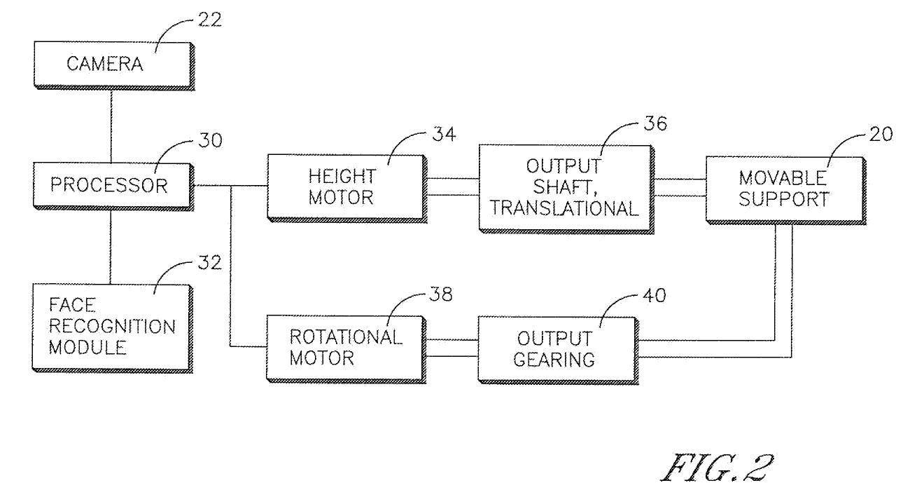

Turning now to FIG. 2, an example embodiment is shown in which signals from the person sensor 22 are sent to a processor 30. The processor 30 may be implemented by the TV processor 26 shown in FIG. 1 or by another processor that is supported in, e.g., the stand 12. When the person sensor 22 is a camera the processor 30 accesses a face recognition module 32 that may be stored on a tangible computer readable medium such as but not limited to the medium 28 shown in FIG. 1. Thus, some or all of the components shown in FIG. 2 may be contained in the stand 12.

The face recognition module, in one example embodiment, may be a relatively simple algorithm that detects human eyes in images from the camera. If the camera is stationary the axis of the field of view of the camera may be assumed by the processor 30 to be a neutral axis of the TV, e.g., the axis to which the TV display is perpendicular when the stand 12 is in a default position. Or, if the camera moves with the stand 12 and/or TV 10 as shown in FIG. 1, the axis of the field of view of the camera may be assumed by the processor 30 to be the actual current axis of the TV, i.e., the axis to which the TV display currently is perpendicular.

In any case, using the face recognition module and principles above the processor 30 can determine, from images received from the camera, the locations of viewers' eyes relative to the angular orientation of the TV for purposes more fully described below. Additionally, the processor 30 can determine the distance of viewers from the TV by, e.g., correlating the distance between the images of two eyes of a viewer to a distance or by correlating a size of an image of a person to a distance or by correlating the signal strength of an IR signal from the person to a distance.

In accordance with logic below, the processor 30 may control a height motor 34 to move to raise and lower a translating output shaft 36 that is coupled to the movable support 20 shown in FIG. 1 to thereby establish a height of the stand 12 (and, thus, of the TV 10). For example, the output shaft 36 may include or be engaged with a vertically-oriented rod that is coupled to the movable support 20 to raise and lower the support 20 relative to the base 18.

Also, the processor 30 may control a rotational motor 38 coupled to output gearing 40 that is configured for imparting motion generated by the motor 38 to rotational motion of the movable support 20. For example, the output gearing 40 may be reduction gears that impart angular rotation of the motor 38 shaft to rotational motion of the movable support 20, albeit at a lower angular velocity than the velocity of the motor 38 shaft.

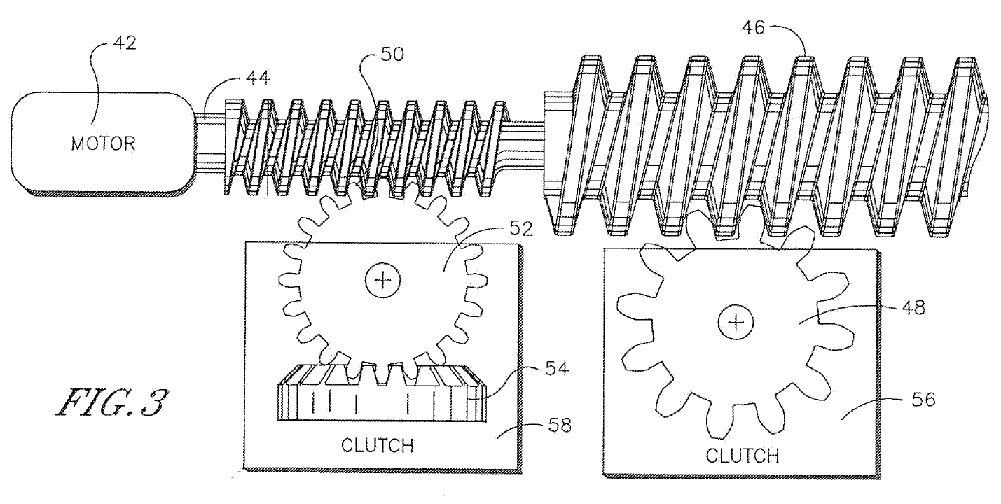

Or, as shown in FIG. 3 a single motor 42 may be coupled to an output shaft 44 a portion 46 of which is configured as a rack for engaging a pinion gear 48. The motor can be energized to move the output shaft translationally left or right looking down on FIG. 3. The pinion gear 48 in turn is coupled to the movable support 20 to rotate the support 20.

The output shaft 44 can also include a toothed portion 50 that meshes with one or more gears 52 which in turn engage a translational toothed rod 54. The toothed rod 52 may be engaged with the movable support 20 shown in FIG. 1 to thereby establish a height of the stand 12.

A rotatable motion clutch 56 can be controlled by the processor 30 shown in FIG. 2 to selectively engage the pinion gear 48 with the rack portion 46 of the output shaft 44. Likewise, a height adjustment clutch 58 can be controlled by the processor 30 shown in FIG. 2 to selectively engage the gears 52/toothed rod 54 with the toothed portion 50 of the output shaft 44.

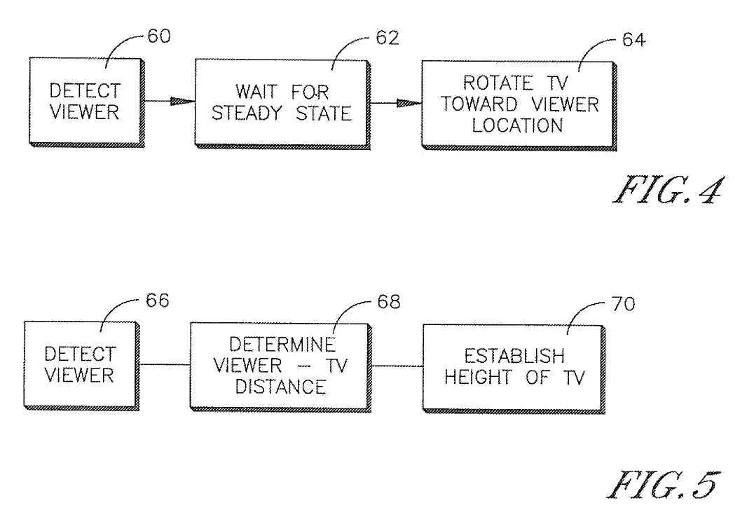

FIGS. 4 and 5 show logic that may be executed by the processor 30 when the TV 10 is energized based on images from the camera, using the face recognition module 32. A viewer of the TV 10 is detected at block 60 by, e.g., detecting a pair of human eyes in images from the camera. A human shape alternatively may detected and used as an indication of a viewer. Multiple viewers may be detected.

At block 62, in example embodiments the processor 30 may wait for the elapse of a steady state period in the event that one or more detected viewers are moving at a speeds and distances greater than a motion threshold prior to moving the stand 12 at block 64. Thus, for example, the motion threshold typically is higher than motion of a sitting viewing simply moving his head but lower than the motion of a viewer walking about in front of the TV, and the steady state period may be one or a few seconds. In this way, excessive motion of the system that might otherwise occur while viewers are moving into preferred viewing locations is avoided, both to conserve energy and to avoid potentially constant repositioning of the TV, which might be distracting.

At block 64, the movable support 20 (and, hence, TV 10) is automatically cased to rotate by the processor 30 to cause the TV 10 (equivalently, the assumed axis of the TV 10 when the TV 10 is placed as intended on the stand 12) to directly face the viewer. When multiple viewers are detected, the average of the angular locations of the viewers can be used.

Blocks 66-70 of FIG. 5 show that in addition or in lieu of angular position of the TV, the height of the TV can be adjusted based on the distance between the TV and one or more viewers. For example, the TV can be raised when the viewer is many yards away from the TV and lowered when the viewer is closer. The precise correlation of height to distant may be empirically determined, and in some embodiments a user may be presented with a GUI for establishing default height-to-distance correlations as preferred by the user, which are subsequently used in the logic of FIG. 5.

At block 66, one or more viewers are detected when the TV 10 is energized in accordance with principles discussed above, and then at block 68 the distance between each detected viewer and the TV is determined, also in accordance with principles discussed above. If multiple viewers are present an average viewer distance may be calculated. Or, only a single distance, e.g., the further viewer distance or the closest viewer distance, may be used.

In any case, at block 70 the distance output at block 68 (e.g., average distance, closest distance, further distance, or only viewer distance) is correlated to height. The TV height is then established by the processor 30 automatically.

While the particular TV WITH VIEWER-ADAPTED HEIGHT AND ANGLE ADJUSTMENT is herein shown and described in detail, it is to be understood that the subject matter which is encompassed by the present invention is limited only by the claims.

What is claimed is:

1. System comprising:
at least one movable support assembly configured to support a TV;
at least one person sensor configured to sense a viewer of the TV; and
at least one processor receiving signals from the person sensor to determine a viewer angle parameter and a viewer distance parameter and based thereon automatically establishing an angular orientation of the movable support assembly and a height of the movable support assembly.

2. The system of claim 1, wherein the movable support assembly can telescope relative to a base in which the movable support assembly reciprocates.

3. The system of claim 1, wherein the processor executes a face recognition module to determine the parameters.

4. The system of claim 1, wherein the processor waits for the elapse of a steady state period in the event that one or more detected viewers are moving at a speeds and distances greater than a motion threshold prior to moving the movable support assembly.

5. The system of claim 1, wherein a viewer can establish a correlation between at least one viewer distance parameter and a height of the movable support assembly.

6. The system of claim 1, wherein if multiple viewers are detected the parameters are averages of corresponding individual viewer parameters.

7. System comprising:
at least one movable support assembly configured to support a TV;
at least one person sensor configured to sense a viewer of the TV; and
at least one processor receiving signals from the person sensor to determine a viewer distance parameter and based thereon automatically establishing a height of the movable support assembly.

8. The system of claim 7, wherein the movable support assembly can telescope relative to a base in which the movable support assembly reciprocates.

9. The system of claim 7, wherein the processor executes a face recognition module to determine the parameter.

10. The system of claim 7, wherein the processor waits for the elapse of a steady state period in the event that one or more detected viewers are moving at a speeds and distances greater than a motion threshold prior to moving the movable support assembly.

11. The system of claim 7, wherein a viewer can establish a correlation between at least one viewer distance parameter and a height of the movable support assembly.

12. The system of claim 7, wherein if multiple viewers are detected the parameter is an average of corresponding individual viewer parameters.

13. System comprising:
at least one movable support assembly configured to support a TV;
at least one person sensor configured to sense a viewer of the TV; and
at least one processor receiving signals from the person sensor to determine a viewer angle parameter and based thereon automatically establishing an angular orientation of the movable support assembly, wherein the processor waits for the elapse of a steady state period in the event that one or more detected viewers are moving at a speeds and distances greater than a motion threshold prior to moving the movable support assembly.

14. The system of claim 13, wherein the movable support assembly can telescope relative to a base in which the movable support assembly reciprocates.

15. The system of claim 13, wherein the processor executes a face recognition module to determine the parameter.

16. The system of claim 13, wherein the processor further determines a viewer distance parameter and based thereon establishes a height of the movable support assembly.

17. The system of claim 16, wherein a viewer can establish a correlation between at least one viewer distance parameter and a height of the movable support assembly.

18. The system of claim 13, wherein if multiple viewers are detected the parameter is an average of corresponding individual viewer parameters.
